(19) United States
(12) Patent Application Publication
(10) Pub. No.: US 2025/0044546 A1
(43) Pub. Date: Feb. 6, 2025

(54) DRIVING MECHANISM

(71) Applicant: TDK TAIWAN CORP., Taoyuan City (TW)

(72) Inventors: Chao-Chang HU, Taoyuan City (TW); Ying-Jen WANG, Taoyuan City (TW)

(21) Appl. No.: 18/792,907

(22) Filed: Aug. 2, 2024

Related U.S. Application Data
(60) Provisional application No. 63/517,770, filed on Aug. 4, 2023.

(51) Int. Cl. G02B 7/09

(52) U.S. Cl. CPC G02B 7/09

(57) ABSTRACT

A driving mechanism for moving an optical element is provided. The driving mechanism includes a fixed part, a movable part, and a driving assembly. The movable part is movably connected to the fixed part for holding the optical clement. The driving assembly is configured for moving the optical element relative to the fixed part.

### CROSS REFERENCE TO RELATED APPLICATIONS

This application claims the benefit of U.S. provisional application No. 63/517,770, filed Aug. 4, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Electronic devices usually use several coils and magnets for adjusting the focus of a lens. However, miniaturization of these electronic devices may increase the difficulty of mechanical design, and it may also lead to low reliability and a low positioning accuracy of the driving mechanism. Therefore, addressing the aforementioned problems has become a challenge.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured for moving the optical element relative to the fixed part.

In some embodiments, the driving mechanism further includes a spring sheet and a plurality of elongated elastic elements, wherein the spring sheet is disposed on the fixed part, and the movable part includes a resilient circuit board, wherein the elastic elements extend along the optical axis to connect the spring sheet to the circuit board, and the optical element is disposed on the circuit board.

### BRIEF DESCRIPTION OF THE DRAWINGS

The present invention can be more fully understood by reading the subsequent detailed description and examples with references made to the accompanying drawings, wherein:

FIG. 1 shows a perspective diagram of a driving mechanism 100 in accordance with an embodiment of the invention.

FIG. 2 shows another perspective diagram of a driving mechanism 100 in FIG. 1.

FIG. 3 shows an exploded view of the driving mechanism 100 in FIGS. 1 and 2.

FIG. 4 shows an exploded view of the first module 10 in FIG. 3.

FIG. 5 is a perspective diagram showing the first coils C1 disposed on the protrusions 112 of the first housing 11.

FIG. 6 is a perspective diagram of the first module 10 with the first coil C1, the first housing 11, and the first optical lens R omitted therefrom.

FIG. 7 is a perspective diagram of the first module 10 after assembly.

FIG. 8 is a perspective diagram showing that the external light L enters the third optical lens P in the-Z direction.

FIG. 9 is a perspective diagram of the driving mechanism 200 in accordance with an embodiment of the invention.

FIG. 10 is another perspective diagram of the driving mechanism 200 in FIG. 9.

FIG. 11 shows an exploded view of the driving mechanism 200 in FIGS. 9 and 10.

FIG. 12 shows an exploded view of the driving unit 203 in FIG. 11.

FIG. 13 is an enlarged partial cross-sectional view of the driving mechanism 200 in FIGS. 9 and 10.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

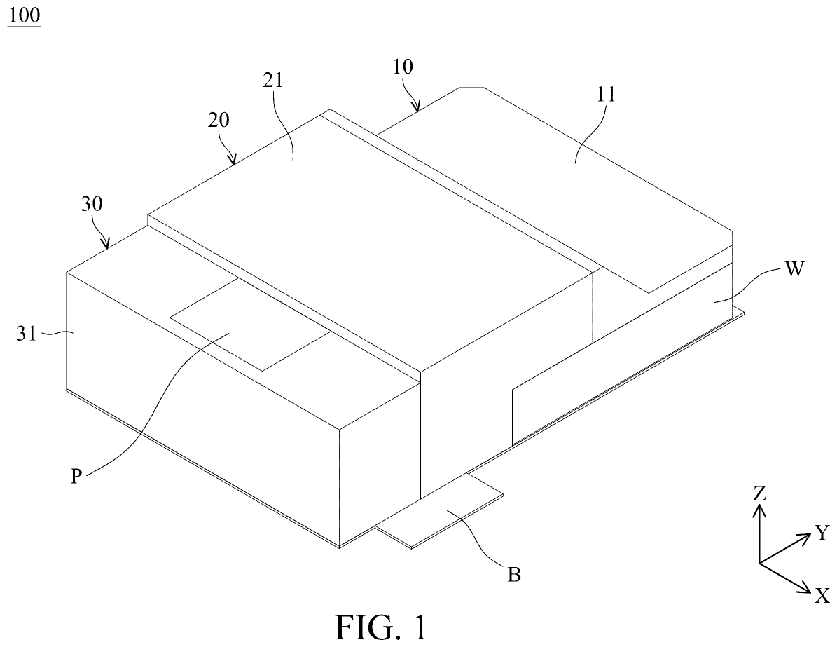

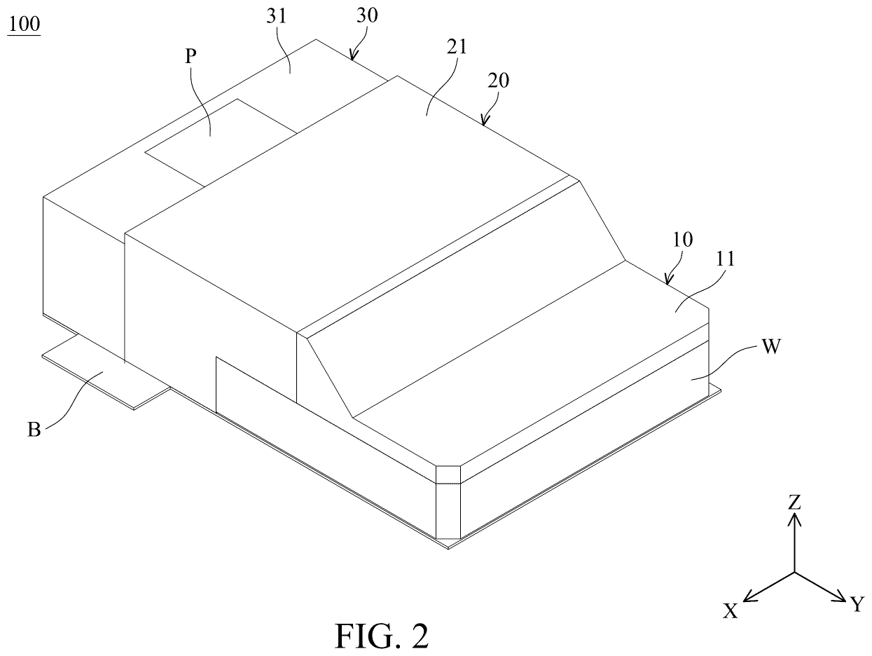

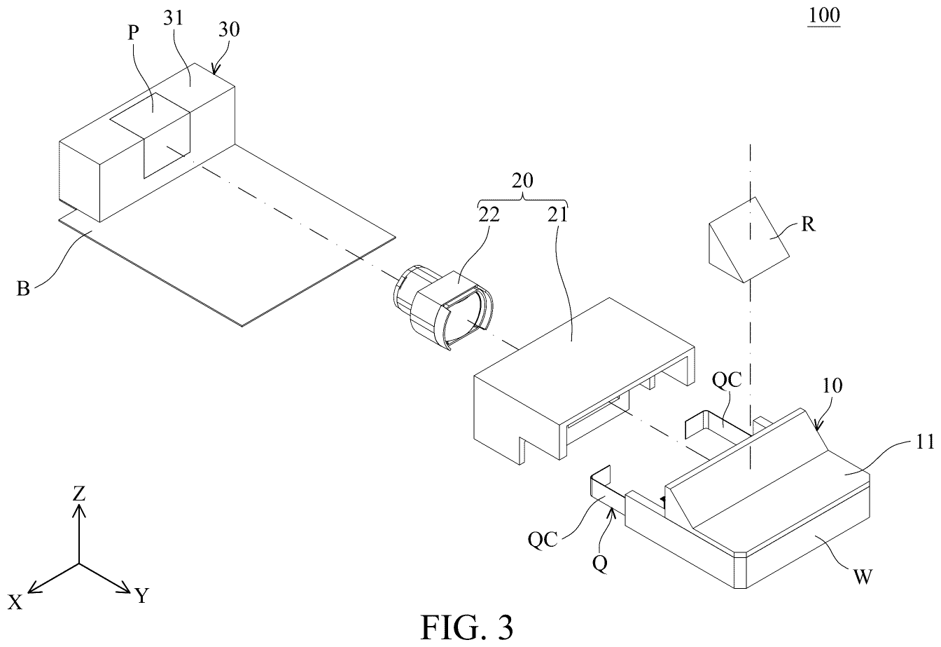

FIG. 1 shows a perspective diagram of a driving mechanism 100 in accordance with an embodiment of the invention. FIG. 2 shows another perspective diagram of a driving mechanism 100 in FIG. 1. FIG. 3 shows an exploded view of the driving mechanism 100 in FIGS. 1 and 2.

Referring to FIGS. 1-3, the driving mechanism 100 in this embodiment is a Voice Coil Motor (VCM) which may be disposed in a cell phone or other portable electronic device for driving an optical element (e.g. transparent lens, prism, or image sensor) to move, thereby achieving the function of Auto-Focusing (AF) or Optical Image Stabilization (OIS).

The driving mechanism 100 primarily comprises a first module 10, a second module 20, and a third module 30. The first module 10 has a first housing 11, a shield W, a first optical lens R (e.g. prism), and a resilient circuit board Q. The first optical lens R is disposed in the first housing 11. The shield W is connected between the first housing 11 and the circuit board Q.

The second module 20 is disposed between the first and third modules 10 and 30, including a second housing 21 and a second optical lens 22 (e.g. transparent lens) affixed to on the second housing 21. Moreover, the third module 30 includes a third housing 31, a third optical lens P (e.g. prism), and a substrate B. The third optical lens P is disposed on the top side of the third housing 31, and the substrate B is affixed to the bottom side of the third housing 31 for concealing and sustaining the circuit board Q, wherein the hardness of the substrate B is greater than the hardness of the circuit board Q.

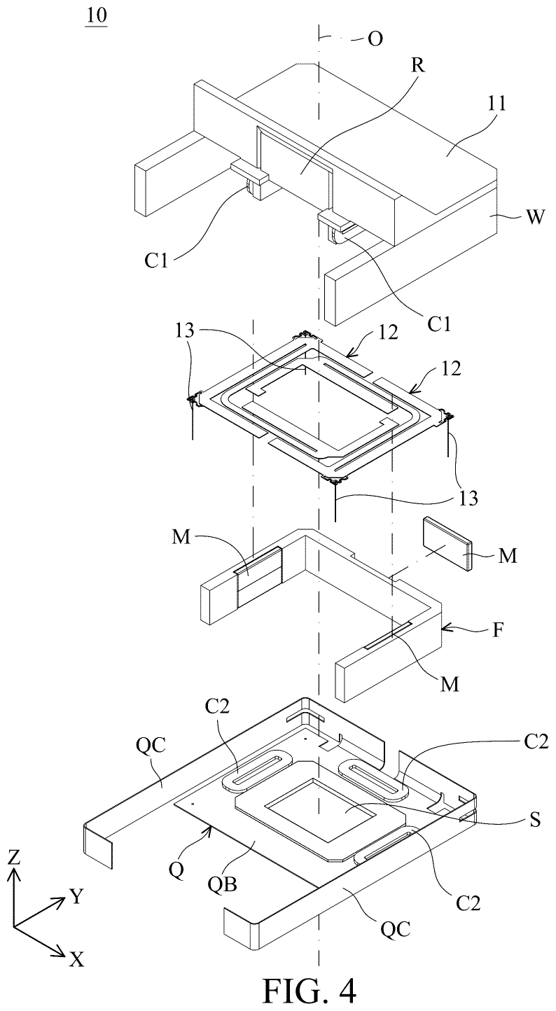

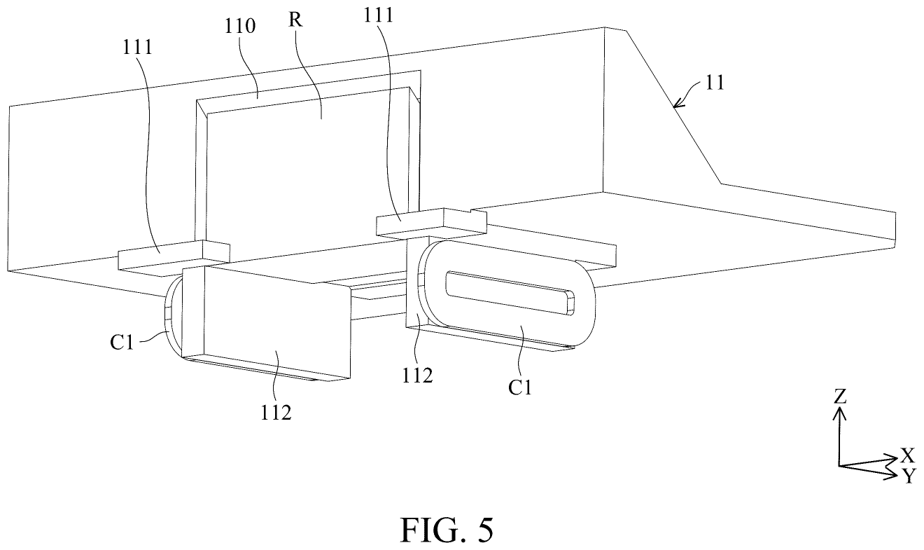

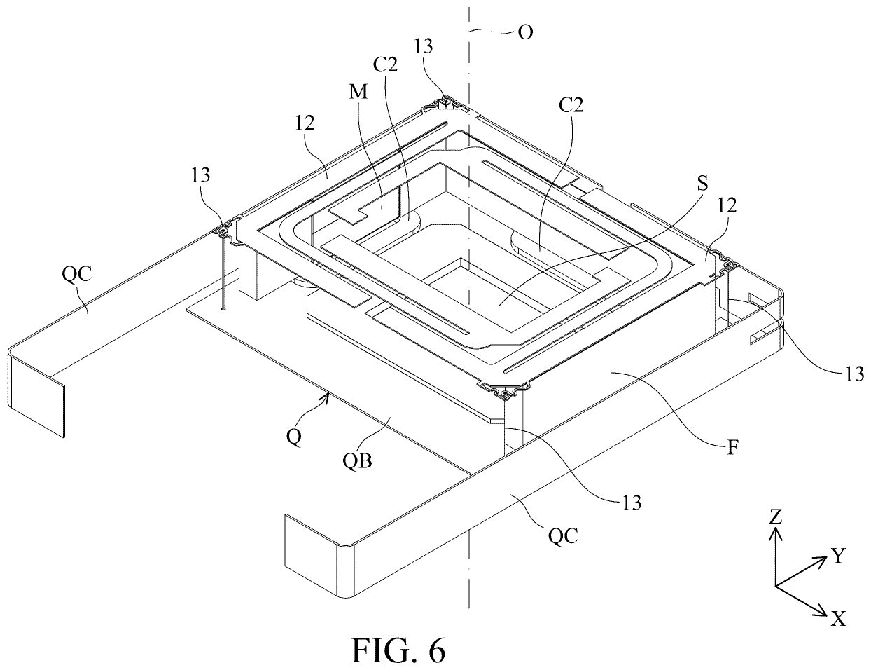

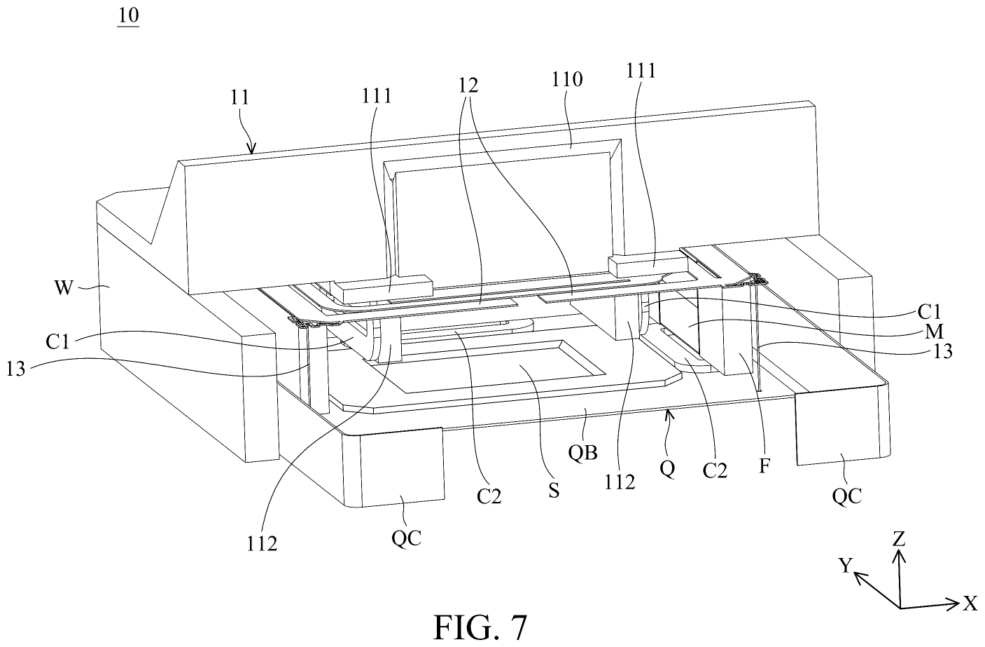

FIG. 4 shows an exploded view of the first module 10 in FIG. 3. FIG. 5 is a perspective diagram showing the first coils C1 disposed on the protrusions 112 of the first housing 11. FIG. 6 is a perspective diagram of the first module 10 with the first coil C1, the first housing 11, and the first optical lens R omitted therefrom. FIG. 7 is a perspective diagram of the first module 10 after assembly.

Referring to FIGS. 4-7, the shield W of the first module 10 form a fixed part of the driving mechanism 100, and a frame F is disposed in the shield W. Here, the shield W and the frame F both have a C-shaped structure facing the-Y direction. Additionally, three magnetic elements M (e.g. magnets) are disposed on three different sides of the frame F.

It can be seen in FIGS. 4 and 5 that the first housing 11 of the first module 10 forms a recess 110, two ribs 111, and two protrusions 112 adjacent to each other. The ribs 111 protrude in the-Y direction from the recess 110, and the protrusions 112 protrude from the bottom side of the first housing 11 in the-Z direction.

In this embodiment, the ribs 111 and the recess 110 partially overlap along the horizontal direction (Y direction). Hence, the recess 110 can be partially covered by the ribs 111, whereby the first optical lens R can be restricted in the recess 110 and prevented from sliding out of the recess 110 in the-Y direction.

Moreover, two coils C1 are disposed on the protrusions 112 of the first housing 11 and located corresponding to two of the magnetic elements M on the frame F.

Specifically, at least a spring sheet 12 (e.g. metal sheet) and several elongated elastic elements 13 (e.g. thin metal rods) are disposed in the shield W. The inner portions of the spring sheets 12 are adhered to the bottom surface of the ribs 111. The elastic elements 13 extend along the Z axis and are connected between the outer portions of the spring sheets 12 and the flat main body QB of the circuit board Q.

It should be noted that the main body QB of the circuit board Q can be movably suspended inside the shield W by the elastic elements 13, and the first coils C1 can be electrically connected to the circuit board Q via the spring sheets 12 and the elastic elements 13. Moreover, as the inner portions of the spring sheets 12 can be aligned and in contact with the protrusions 112 during assembly, precise positioning between the spring sheets 12 and the first housing 11 can also be achieved.

In some embodiments, the spring sheets 12 and the first optical lens R can be adhered to the first housing 11 at the same time. Therefore, not only assembly efficiency of the driving mechanism 100 can be increased, structural strength and reliability of the driving mechanism 100 can also be improved.

As shown in FIGS. 4 and 6-7, the frame F is connected to the outer portion of the spring sheets 12, Three second coils C2 and a rectangular optical element S (e.g. image sensor) are disposed on the main body QB of the circuit board Q. Here, the second coils C2 are disposed on three different sides of the optical element S and respectively located below the three magnetic elements M on the frame F.

It should be noted that the outer portions of the spring sheets 12 are higher than the inner portions of the spring sheets 12 in the Z direction, and the optical element S has an optical axis O that is parallel to the Z direction (FIGS. 4 and 6).

The magnetic elements M and the first and second coils C1 and C2 constitute a driving assembly of the driving mechanism 100 for moving the optical element S. When a current is applied to the first coils C1, the first coils C1 and the magnetic elements M can generate an electromagnetic force parallel to the Z direction and the optical axis O. Hence, the frame F, the magnetic elements M on the frame F, the main body QB of the circuit board Q, the optical element S, and the second coils C2 can be driven to move relative to the fixed part (the shield W and the first housing 11) along the Z axis, thereby achieving the function of Auto-Focusing (AF) or Optical Image Stabilization (OIS) along the Z axis.

Additionally, When a current is applied to the second coils C2, the second coils C2 and the magnetic elements M can generate an electromagnetic force in a horizontal direction that is parallel to the X or Y axis. Hence, the main body QB of the circuit board Q, the optical element S, and the second coils C2 can be driven to move relative to the frame F and the fixed part (the shield W and the first housing 11) in the horizontal direction (X or Y direction), thereby achieving the function of Optical Image Stabilization (OIS) of the driving mechanism 100 along the horizontal direction (X or Y direction).

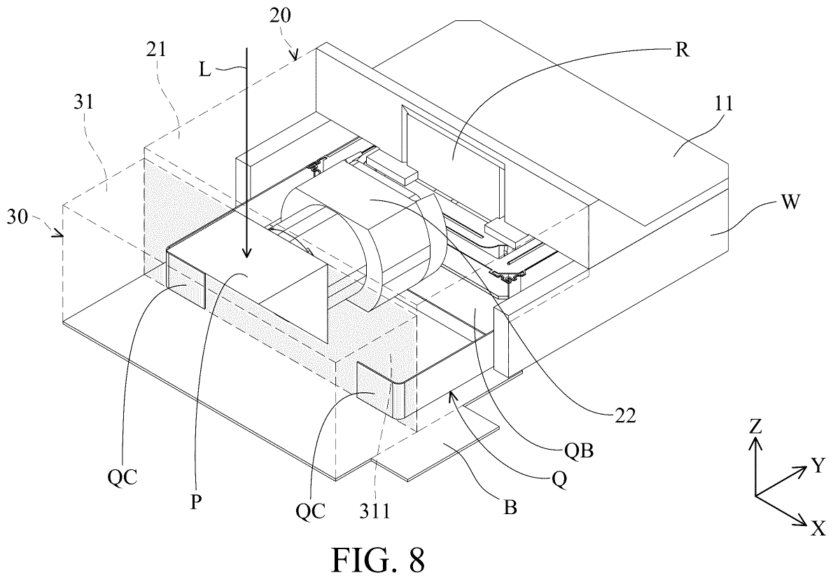

FIG. 8 is a perspective diagram showing that the external light L enters the third optical lens P in the-Z direction. As shown in FIG. 8, the external light L can enter the third optical lens P in the-Z direction. The external light L is then reflected by the third optical lens P and propagates through the second optical lens 22 to the first optical lens R. Subsequently, the external light L is reflected by the first optical lens R and propagates to the optical element S on the main body QB of the circuit board Q along the-Z direction, thereby forming a digital image.

Referring to FIGS. 4 and 6-8, the resilient circuit board Q in this embodiment constitutes a movable part of the driving mechanism 100. The circuit board Q includes a flat main body QB and two C-shaped extending portions QC that extend from a side of the main body QB. Specifically, the extending portions QC are bent relative to the main body QB and parallel to the Z axis. Thus, the optical element S and the first and second coils C1 and C2 inside the first module 10 can be electrically connected to the conductive pads (not shown) on the inner wall 311 of the third housing 31 (FIG. 8) via the extending portions QC extending along the-Y direction, whereby miniaturization of the driving mechanism 100 and the electronic device can be achieved.

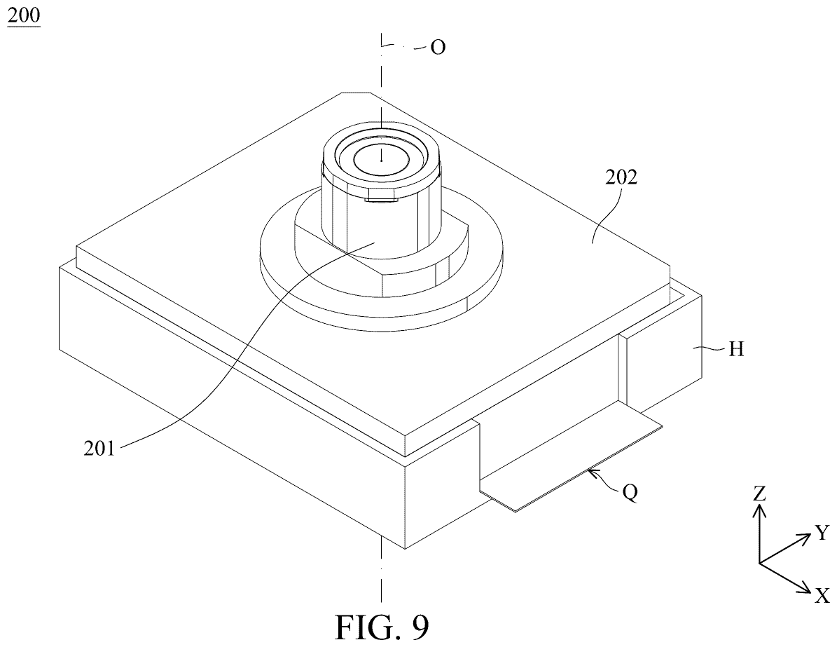

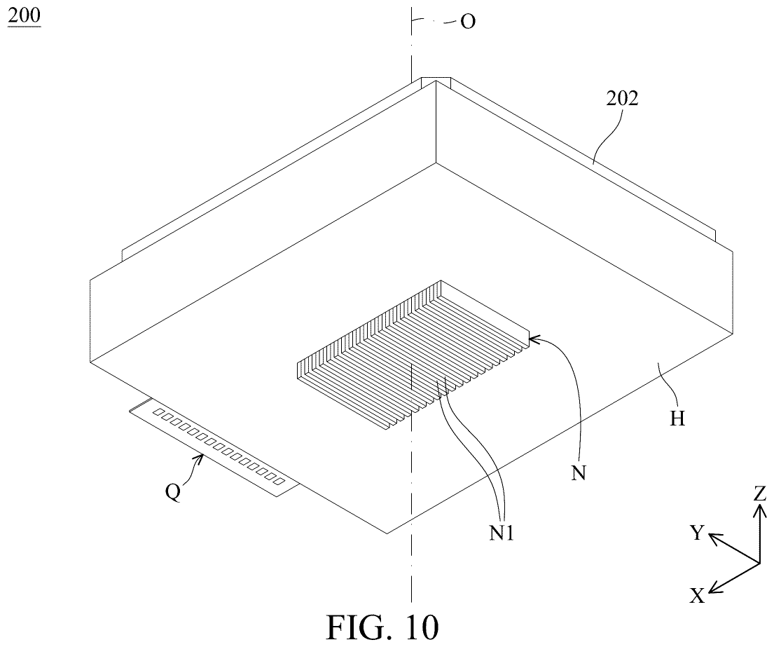

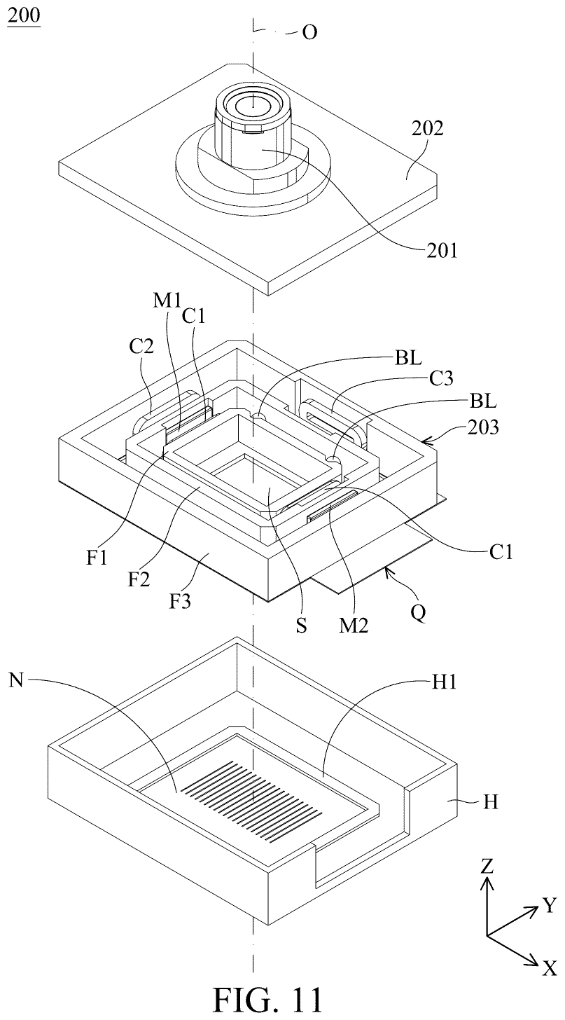

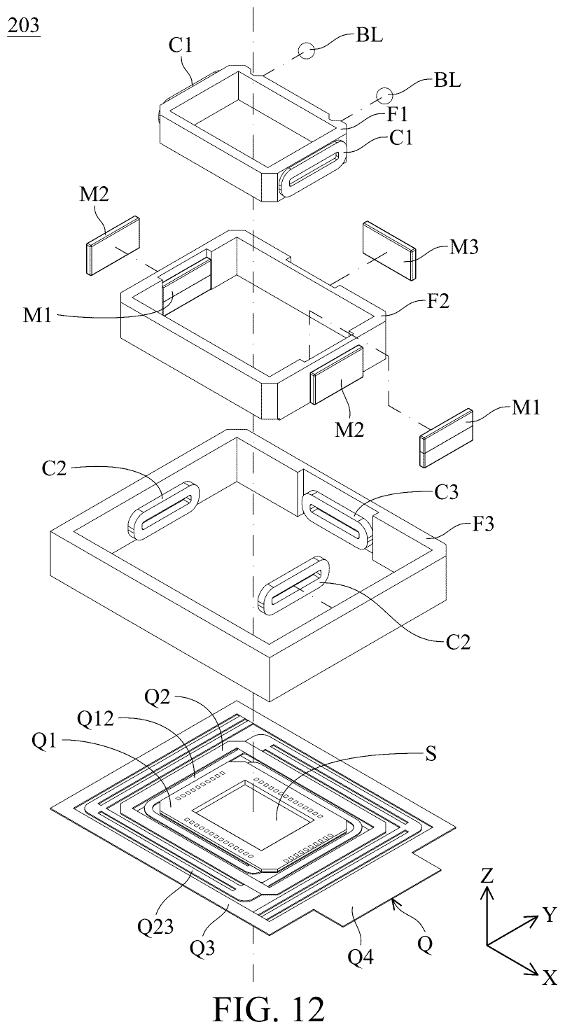

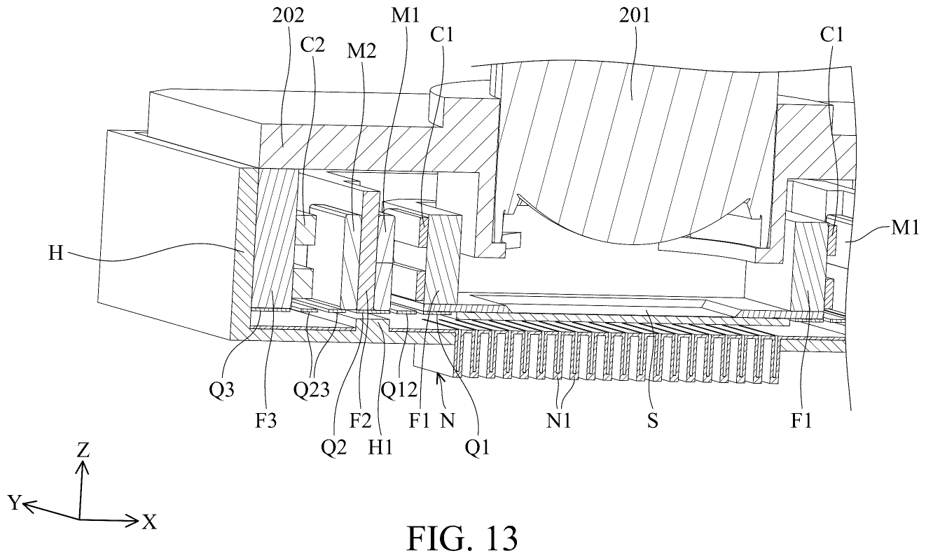

FIG. 9 is a perspective diagram of the driving mechanism 200 in accordance with an embodiment of the invention. FIG. 10 is another perspective diagram of the driving mechanism 200 in FIG. 9. FIG. 11 shows an exploded view of the driving mechanism 200 in FIGS. 9 and 10. FIG. 12 shows an exploded view of the driving unit 203 in FIG. 11. FIG. 13 is an enlarged partial cross-sectional view of the driving mechanism 200 in FIGS. 9 and 10.

Referring to FIGS. 9-13, the driving mechanism 200 in another embodiment of the invention is a Voice Coil Motor (VCM) which may be disposed in a cell phone or other portable electronic device for driving an optical element (e.g. transparent lens, prism, or image sensor) to move, thereby achieving the function of Auto-Focusing (AF) or Optical Image Stabilization (OIS).

The driving mechanism 200 primarily comprises an optical lens 201, a top cover 202, a driving unit 203, a plastic shield H and a metal member N. The optical lens 201 is disposed at the center of the top cover 202, and the top cover 202 is affixed to the shield H. Additionally, the driving unit 203 is disposed in the shield H, and the metal member N is disposed on the bottom surface of the shield H.

It should be noted that the metal member N has low magnetic permeability, and it can conceal the optical element S (e.g. image sensor) inside the driving mechanism 200. Hence, the optical element S can be protected and prevented from electromagnetic interference (EMI) from the electronic elements outside of the driving mechanism 200. Moreover, the metal member N forms a plurality of thermal fins N1 that extend through the shield H and protrude from the bottom side of the shield H, thus greatly enhancing heat dissipation of the driving mechanism 200.

As shown in FIG. 12, the driving unit 203 primarily includes a first frame F1, a second frame F2, a third frame F3, and a circuit board Q. In this embodiment, the driving unit 203 constitutes a movable part of the driving mechanism 200 that is movable relative to the top cover 202 and the shield H (fixed part). The circuit board Q has a first connecting portion Q1, a second connecting portion Q2, a third connecting portion Q3, a terminal portion Q4, a first resilient structure Q12, and second resilient structure Q23.

The thin and meandering first resilient structure Q12 is connected between the first and second connecting portions Q1 and Q2, and the thin and meandering second resilient structure Q23 is connected between the second and third connecting portions Q2 and Q3. The terminal portion Q4 protrude from a side of the third connecting portion Q3 in the X direction.

In this embodiment, the coils and the optical element S (image sensor) in the driving unit 203 may be electrically connected to the circuit board Q via conductive wires, and they can be further electrically connected to the external circuit through the terminal portion Q4 of the circuit board Q.

It should be noted that the top cover 202 and the shield H constitute a fixed part of the driving mechanism 200. The first frame F1, the second frame F2, and the third frame F3 are disposed in the shield H and respectively have a hollow rectangular structure.

The first frame F1 is mounted to the first connecting portion Q1, the second frame F2 is mounted to the second connecting portion Q2, and the third frame F3 is mounted to the third connecting portion Q3, wherein the third frame F3, the shield H, and the top cover 202 are adhered to each other (FIG. 13).

In this embodiment, the thickness of the first frame F1 along the Z axis is less than the thickness of the second frame F2 along the Z axis, and the thickness of the second frame F2 along the Z axis is less than the thickness of the third frame F3 along the Z axis.

It can be seen in FIGS. 11-13 that two first coils C1 are disposed on the outer side of the first frame F1. Two first magnets M1 are disposed on the inner side of the second frame F2 and located corresponding to the first coils C1. The second frame F2 is situated between the first and third frames F1 and F3, and the optical element S (image sensor) is disposed at the center of the first connecting portion Q1 of the circuit board Q.

Furthermore, two second magnets M2 and a third magnet M3 are disposed on the outer side the second frame F2. Two second coils C2 and a third coil C are disposed on the inner side of the third frame F3 and located corresponding to the second magnets M2 and the third magnet M3 on the second frame F2.

The first, second, third magnets M1-M3 and the first, second, third coils C1-C3 constitute a driving assembly of the driving mechanism 200 for moving the optical element S. When a current is applied to the first coils C1, the first coils C1 and the first magnets M1 can generate an electromagnetic force parallel to the Z direction and the optical axis O of the optical element S. Hence, the first frame F1 and the optical element S on the first connecting portion Q1 can be driven to move relative to the second frame F2 along the Z axis, thereby achieving the function of Auto-Focusing (AF) or Optical Image Stabilization (OIS) along the Z axis

Additionally, when a current is applied to the second coils C2, the second coils C2 and the second magnets M2 can generate an electromagnetic force that is parallel to the X axis. Hence, the first frame F1, the optical element S on the first connecting portion Q1, the second frame F2, and the second connecting portion Q2 can be driven to move relative to the shield H along the X axis, thereby achieving the function of Optical Image Stabilization (OIS) of the driving mechanism 100 along the X axis.

Similarly, when a current is applied to the third coil C3, the third coil C3 and the third magnet M3 can generate an electromagnetic force that is parallel to the Y axis. Hence, the first frame F1, the optical element S on the first connecting portion Q1, the second frame F2, and the second connecting portion Q2 can be driven to move relative to the shield H along the Y axis, thereby achieving the function of Optical Image Stabilization (OIS) of the driving mechanism 100 along the Y axis.

In this embodiment, several rollers BL are disposed between the first and second frames F1 and F2, and the first frame F1 can smoothly slide relative to the second frame F2 along the Z axis (along the optical axis O of the optical element S), whereby the reliability of the driving mechanism 200 can also be improved.

As shown in FIG. 13, the first and second coils C1 and C2 at least partially overlap the optical lens 201 in the horizontal direction (X direction). Thus, the thickness of the driving mechanism 200 along the Z axis can be efficiently reduced, thereby achieving miniaturization of the driving mechanism 200 and the electronic device.

It should be noted that a gap is formed between the circuit board Q and the metal member N/the shield H. Specifically, a rectangular rib H1 is formed on the bottom surface of the shield H (FIGS. 11 and 13) and located corresponding to the second connecting portion Q2 of the circuit board Q. Here, the connecting portion Q2 and rib H1 at least partially overlap when viewed along the Z axis (the optical axis O of the optical element S).

When the driving mechanism 200 is impacted by an external force and the circuit board Q moves along the −Z direction relative to the shield H, the rib H1 can contact the second connecting portion Q2 of the circuit board Q so as to restrict the circuit board Q in a limit position. Therefore, the optical element S at the center of the circuit board Q can be prevented from collision with the metal member N.

In some embodiments, the damping gel may also be disposed between the circuit board Q and the metal member N to prevent the collision between the circuit board Q and the metal member N.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element, comprising:
a fixed part;
a movable part, movably connected to the fixed part for holding the optical element, wherein the optical element has an optical axis; and
a driving assembly, configured for moving the movable part relative to the fixed part.

2. The driving mechanism as claimed in claim 1, further comprising a spring sheet and a plurality of elongated elastic elements, wherein the spring sheet is disposed on the fixed part, and the movable part includes a resilient circuit board, wherein the elastic elements extend along the optical axis to connect the spring sheet to the circuit board, and the optical element is disposed on the circuit board.

3. The driving mechanism as claimed in claim 2, further comprising a frame disposed on the circuit board, the fixed part includes a shield and a first housing connected to each other, and the frame is disposed in the shield, wherein the driving assembly includes a first coil disposed on the first housing and a first magnet disposed on the frame, and the first coil is electrically connected to the circuit board via the spring sheet and the elastic elements.

4. The driving mechanism as claimed in claim 3, wherein the first housing forms a recess and a protrusion located adjacent to each other, the protrusion protrudes from the bottom of the first housing, the recess is configured to receive a first optical lens, and the first coil is disposed on the protrusion.

5. The driving mechanism as claimed in claim 3, wherein the first housing forms a recess and a rib located adjacent to each other, the recess is configured to receive a first optical lens, and the rib and the recess partially overlap along a horizontal direction that is perpendicular to the optical axis.

6. The driving mechanism as claimed in claim 5, wherein an inner portion of the spring sheet is adhered to the rib.

7. The driving mechanism as claimed in claim 6, wherein the elastic elements are connected between an outer portion of the spring sheet and the circuit board.

8. The driving mechanism as claimed in claim 7, wherein the outer portion of the spring sheet is higher than the inner portion of the spring sheet along the optical axis.

9. The driving mechanism as claimed in claim 2, wherein the circuit board has a main body and an extending portion, the optical element is disposed on the main body, and the extending portion is bent relative to the main body.

10. The driving mechanism as claimed in claim 9, wherein the extending portion has a C-shaped structure that is parallel to the optical axis.

11. The driving mechanism as claimed in claim 1, further comprising a metal member, wherein the movable part includes a resilient circuit board, the optical element is disposed on the circuit board, and the fixed part includes a shield and a top cover connected to each other, wherein the metal member and the circuit board are disposed in the shield, and an optical lens is disposed on the top cover, wherein the metal member has low magnetic permeability, and the optical element is concealed by the metal member.

12. The driving mechanism as claimed in claim 11, wherein the metal member has a plurality of thermal fins extending through the shield and protruding from the bottom side of the shield.

13. The driving mechanism as claimed in claim 11, wherein the shield forms a rib, and when the circuit board moves relative to the shield along the optical axis to a limit position, the rib contacts the circuit board and restrict the circuit board in the limit position.

14. The driving mechanism as claimed in claim 11, further comprising a damping gel disposed between the circuit board and the metal member.

15. The driving mechanism as claimed in claim 11, wherein the movable part further includes a first frame and a second frame, and the driving assembly includes a first coil disposed on the first frame and a first magnet disposed on the second frame, wherein the circuit board has a first connecting portion, a second connecting portion, and a first resilient structure, the first frame is disposed on the first connecting portion, the second frame is disposed on the second connecting portion, and the first resilient structure is connected between the first and second connecting portions.

16. The driving mechanism as claimed in claim 15, wherein the first coil and the optical lens at least partially overlap in a horizontal direction that is perpendicular to the optical axis.

17. The driving mechanism as claimed in claim 15, wherein the circuit board further has a third connecting portion and a second resilient structure, and the movable part further includes a third frame disposed on the third connecting portion, wherein the second resilient structure is connected between the second and third connecting portions.

18. The driving mechanism as claimed in claim 17, wherein the driving assembly further includes a second coil disposed on the second frame and a second magnet disposed on the third frame.

19. The driving mechanism as claimed in claim 18, wherein the third frame is affixed to the shield, and the second frame is located between the first and third frames.

20. The driving mechanism as claimed in claim 19, wherein the thickness of the first frame along the optical axis is less than the thickness of the second frame along the optical axis, and the thickness of the second frame along the optical axis is less than the thickness of the third frame along the optical axis.
